(19) United States
(12) Patent Application Publication
(10) Pub. No.: US 2026/0154448 A1
(43) Pub. Date: Jun. 4, 2026

(54) SYSTEM AND METHOD FOR AUTOMATED MASKING OF PERSONALLY IDENTIFIABLE INFORMATION DATA

(71) Applicant: The Toronto-Dominion Bank, Toronto (CA)

(72) Inventors: Senthil Muthukumaran SELVARAJ, Oakville (CA); Ivan CHAN, Toronto (CA); Srinivasan SARMAN, Oakville (CA); Aayush KATHURIA, Brampton (CA)

(21) Appl. No.: 18/965,530

(22) Filed: Dec. 2, 2024

(51) Int. Cl. G06F 21/62

(52) U.S. Cl. CPC G06F 21/6254

(57) ABSTRACT

Computing platforms, methods, and storage media for automated masking of personally identifiable information data are disclosed. Exemplary implementations may: receive input data comprising PII data associated with an input data label; automatically assign a masking process for the PII data based on a comparison of the input data label with stored masking parameters and based on a set of stored masking processes, the set of stored masking processes being mapped to a set of input data labels comprising the input data label associated with the PII data; automatically create and execute one or more masking jobs associated with the masking process; and generate masked PII data based on execution of the one or more masking jobs.

### FIELD

The present disclosure relates to data communications, including but not limited to computing platforms, methods, and storage media for automated masking of personally identifiable information data.

### BACKGROUND

In data communications, servers and applications may send and receive different types of data. Depending on the data being transmitted, different security parameters and arrangements may apply.

For example, consider the transmission of personally identifiable information (PII). Some organizational policies do not permit the processing of PII data, for example in a lower environment. This is in contrast to a production environment in which PII data processing is permitted. One approach is for a person to manually identify the PII data and attempt to determine the best method to mask the particular type of PII data.

Improvements in approaches for automated masking of PII data are desirable.

### BRIEF DESCRIPTION OF THE DRAWINGS

Embodiments of the present disclosure will now be described, by way of example only, with reference to the attached Figures.

FIG. 1 illustrates a block and flow diagram of an apparatus configured for automated masking of personally identifiable information data, in accordance with one or more embodiments.

FIG. 2 illustrates a system configured for automated masking of personally identifiable information data, in accordance with one or more embodiments.

FIG. 3 illustrates a method for automated masking of personally identifiable information data, in accordance with one or more embodiments.

FIG. 4 illustrates is a block and flow diagram of a classification engine of an apparatus configured for automated masking of personally identifiable information data, in accordance with one or more embodiments.

FIG. 5 is a block and flow diagram of a masking engine of an apparatus configured for automated masking of personally identifiable information data, in accordance with one or more embodiments.

FIG. 6 is a block and flow diagram of a validation engine of an apparatus configured for automated masking of personally identifiable information data, in accordance with one or more embodiments.

FIG. 7 is a block and flow diagram of a comparison tool of an apparatus configured for automated masking of personally identifiable information data, in accordance with one or more embodiments.

FIG. 8 is a block and flow diagram of a first data comparison example, in accordance with one or more embodiments.

FIG. 9 is a block and flow diagram of a second data comparison example, in accordance with one or more embodiments.

### DETAILED DESCRIPTION

Computing platforms, methods, and storage media for automated masking of personally identifiable information data are disclosed. Exemplary implementations may: receive input data comprising PII data associated with an input data label; automatically assign a masking process for the PII data based on a comparison of the input data label with stored masking parameters and based on a set of stored masking processes, the set of stored masking processes being mapped to a set of input data labels comprising the input data label associated with the PII data; automatically create and execute one or more masking jobs associated with the masking process; and generate masked PII data based on execution of the one or more masking jobs.

One or more embodiments of the present disclosure provide a platform to automatically identify personally identifiable information data and automatically mask the PII data based on a selected masking scheme.

Personally identifiable information (PII) is defined in a National Institute of Standards and Technology (NIST) document, based on a United States Government Accountability Office report, as “any information about an individual maintained by an agency, including (1) any information that can be used to distinguish or trace an individual's identity, such as name, social security number, date and place of birth, mother's maiden name, or biometric records; and (2) any other information that is linked or linkable to an individual, such as medical, educational, financial, and employment information.” PII comprises sensitive data subject to information governance. PII may include payment card information (PCI) or personal health information (PHI).

One or more embodiments of the present disclosure provide a system to automatically mask PII data, for example by intercepting and masking PII data before it is passed to a lower environment. A system in accordance with one or more embodiments may scan definitions of tables related to the PII data to determine the best masking algorithm to apply, based on a PII data classification. A system in accordance with one or more embodiments may automatically create jobs based on classifications, and a masking engine can execute and run the jobs in the lower environment. A comparison engine may compare data pre-masking and post-masking, to determine whether masking actually occurred. A system in accordance with one or more embodiments may automate the obfuscation of production data in a lower environment quickly, compared to existing manual approaches.

One aspect of the present disclosure relates to an apparatus or a computing platform configured for automated masking of personally identifiable information data. The apparatus or computing platform may include a non-transient computer-readable storage medium having executable instructions embodied thereon. The apparatus or computing platform may include one or more hardware processors configured to execute the instructions. The processor(s) may execute the instructions to receive input data comprising PII data associated with an input data label. The processor(s) may execute the instructions to automatically assign a masking process for the PII data based on a comparison of the input data label with stored masking parameters and based on a set of stored masking processes, the set of stored masking processes being mapped to a set of input data labels comprising the input data label associated with the PII data. The processor(s) may execute the instructions to automatically create and execute one or more masking jobs associated with the masking process. The processor(s) may execute the instructions to generate masked PII data based on execution of the one or more masking jobs.

Another aspect of the present disclosure relates to a method for automated masking of personally identifiable information data. The method may include receiving input data comprising PII data associated with an input data label. The method may include automatically assigning a masking process for the PII data based on a comparison of the input data label with stored masking parameters and based on a set of stored masking processes, the set of stored masking processes being mapped to a set of input data labels comprising the input data label associated with the PII data. The method may include automatically creating and executing one or more masking jobs associated with the masking process. The method may include generating masked PII data based on execution of the one or more masking jobs.

Yet another aspect of the present disclosure relates to a non-transient computer-readable storage medium having instructions embodied thereon, the instructions being executable by one or more processors to perform a method for automated masking of personally identifiable information data. The method may include receiving input data comprising PII data associated with an input data label. The method may include automatically assigning a masking process for the PII data based on a comparison of the input data label with stored masking parameters and based on a set of stored masking processes, the set of stored masking processes being mapped to a set of input data labels comprising the input data label associated with the PII data. The method may include automatically creating and executing one or more masking jobs associated with the masking process. The method may include generating masked PII data based on execution of the one or more masking jobs.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

Embodiments of the present disclosure provide a system that enables automated masking of PII data.

Some environments have a policy direction that PII data cannot come in to a lower environment, since all users may have access to the lower environment. To ensure that no PII hits the lower environment, it is necessary to mask the data. Masking is a long and arduous process.

According to a known approach, the masking of PII data is a manual process, including setting up jobs and rules to map PII data. Such a known approach can be slow, arduous and primarily manual. The manual process may employ the use of third party tools, for example in identifying algorithms that should be assigned to masking certain fields.

One or more embodiments of the present disclosure provide an engine that identifies PII data. In an embodiment, the engine scans definitions of tables and IMS segments to determine the best algorithm to apply. For example, one masking algorithm may comprise tokenization of a first name or address. The engine or algorithm may be configured to detect that the field in question looks like an address field, and if it's an address field, assign algorithm #1 to it. Such a process can be followed for every identified field in the table, across multiple tables, based off the field definition. The novel process includes identification of algorithms to assign to masking a particular data field.

According to a known approach, a user creates masking jobs, and creates job categories, with all of these steps being manual.

There is a technical problem associated with known approaches in that the masking of PII data is a manual process. Typically, data steward (a person) would identify fields to be masked, and send this data to another person to manually look and determine which masking process or algorithm to assign, and classify based on data in a spreadsheet. One or more embodiments of the present disclosure provide a technical solution by automatically assigning a masking process for masking PII data, based on a comparison of an input data label associated with the PII data with stored data masking parameters. There is a further technical problem in that after a masking process is manually identified, there is further manual work of creating jobs to be executed to perform the masking. One or more embodiments of the present disclosure provide a further technical solution by automatically creating and executing one or more masking jobs associated with the masking process.

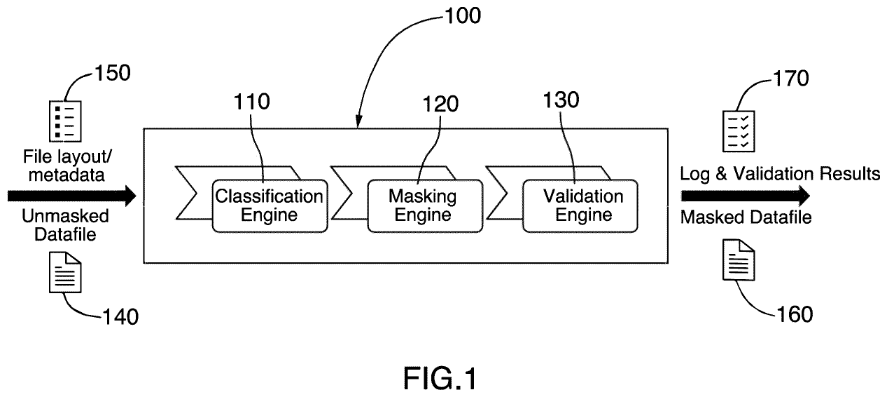

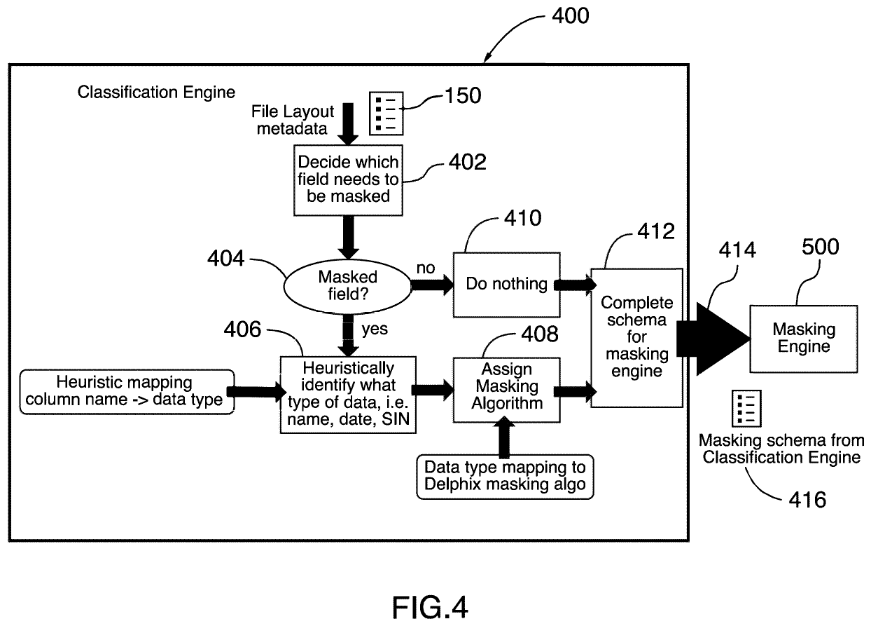

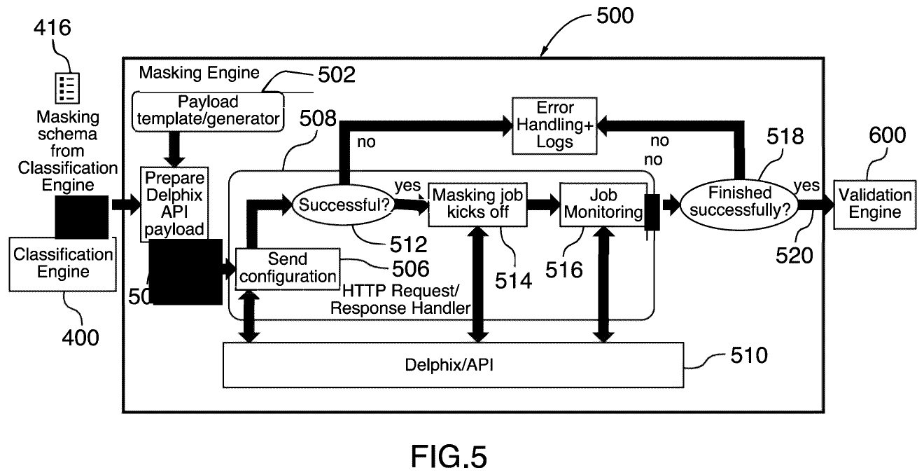

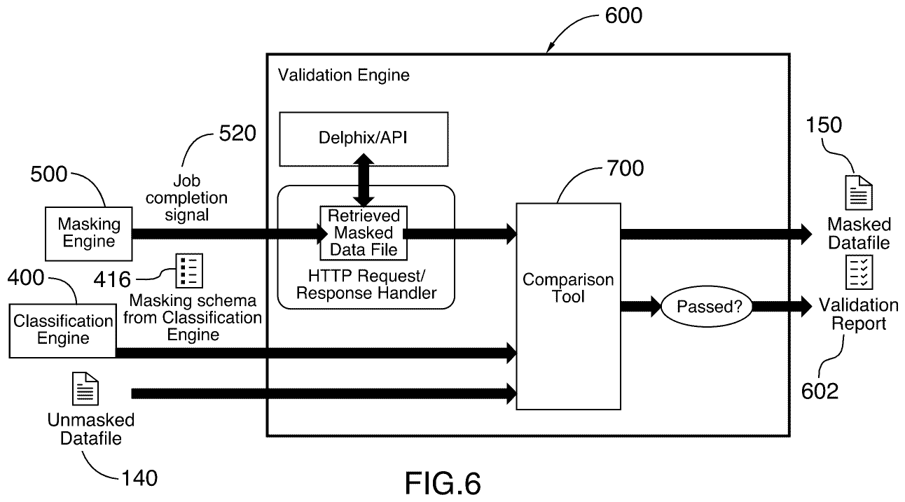

FIG. 1 illustrates a block and flow diagram of an apparatus 100, or a system 100, configured for automated masking of personally identifiable information data, in accordance with one or more embodiments. As shown in FIG. 1, the apparatus 100 may comprise a classification engine 110, a masking engine 120 and a validation engine 130. The system may receive an unmasked datafile 140 which is characterized by a file layout 150, and may be configured to output a masked datafile 160, and may also output a log and validation results 170. Features and characteristics of the classification engine, the masking engine and the validation engine will be described in further detail in relation to FIG. 4, FIG. 5 and FIG. 6, respectively.

The apparatus 100 may be configured for automated masking of personally identifiable information data. The apparatus 100 may comprise: a non-transient computer-readable storage medium having executable instructions embodied thereon; and one or more hardware processors configured to execute the instructions to: receive input data comprising personally identifiable information data associated with an input data label; automatically assign a masking process for the PII data based on a comparison of the input data label with stored masking parameters and based on a set of stored masking processes, the set of stored masking processes being mapped to a set of input data labels comprising the input data label associated with the PII data; automatically create and execute one or more masking jobs associated with the masking process; and generate masked PII data based on execution of the one or more masking jobs.

The apparatus 100 in accordance with one or more embodiments may be configured to utilize APIs that a third party engine provides, and automatically create jobs based on classifications. Once the jobs are created, the masking engine can execute and run the jobs in the lower environment.

The apparatus 100 may be configured to identify PII data, and based on the type of PII data identified, propose a proper algorithm to mask them to lower environment. A final piece of the masking engine is validating or verifying that the data has been modified. A comparison engine compares data pre-masking and post-masking, and determines if masking actually occurred.

The apparatus 100 may look at the data itself, as well as the description of the field. For example, date fields can have different formats, so the apparatus may determine the date format and apply the right masking algorithm based on the date format. In an example implementation, a first date masking process may be defined for date format YYYY-MM-DD, and second and third date masking processes may be defined for date formats DD-MM-YYYY and for DD-MMM-YY. If the first date format is used and identified or detected, the system 100 may automatically assign, based on a comparison of the input data label (i.e. date in a first date format) with stored data masking parameters (i.e. the first date format), a masking process (i.e. the first date masking process) for the PII data based on a comparison of the input data label and a set of stored masking processes (i.e. first, second and third date masking processes), the set of stored masking processes being mapped to a set of input data labels (i.e. date in first, second and third date formats) comprising the input data label associated with the PII data (i.e. date in a first date format).

One or more embodiments of the present disclosure automate the ability for a system to automatically obfuscate production data into a lower environment quickly.

In an embodiment, the apparatus 100 identifying different types of PII data may comprise a type of lookup table, in a section that is hardcoded with if/then statements. The engine may be configured to look at the field, determine it's a first name field, therefore it's a text field; because it's a text field, a certain algorithm gets assigned.

The granularity of identification by the engine may be based on the data type or on the identified field. For example, the apparatus 100 may be configured to determine a difference between an address field and a text field. The determination may be based on a combination of description field and data type. A business description may describe what a field it is. The apparatus 100 may be configured to determine the best algorithm from a list of available masking algorithms. The apparatus 100 may also be configured to obtain or create the list of available masking algorithms. Lookups may comprise an explanation of the algorithm and how it works. In an embodiment, one or more of field name, field description, and data type are used in determining the best masking algorithm or making process.

According to a known approach, a data steward would identify all of the fields to be masked, and identify fields underneath. This manual identification would then get sent to another person to manually look and determine which algorithm gets assigned, and classify based on data in a spreadsheet.

Automation according to one or more embodiments of the present disclosure takes part of the data steward's job (identification), and the apparatus 100 creates automation to: identify type of data, and determine what type of algorithm needs to be assigned. The apparatus 100 may use the description of the field from the database itself, which may be an input of what is masking the input schemas, etc.

The apparatus 100 may scan the name of the field, then determine the masking process. For example, a field for an address may not always have the label “address”, and may sometimes be named “addr”, or something similar, or an equivalent in another language such as “adresse” in French. The apparatus 100 may store multiple combinations of different labels for an address field, to determine if that field is an address field. The apparatus 100 may store a list of algorithms, but the algorithms themselves are stored elsewhere. The apparatus 100 may have or provide a link to the stored algorithms, and assign the algorithm based on identification.

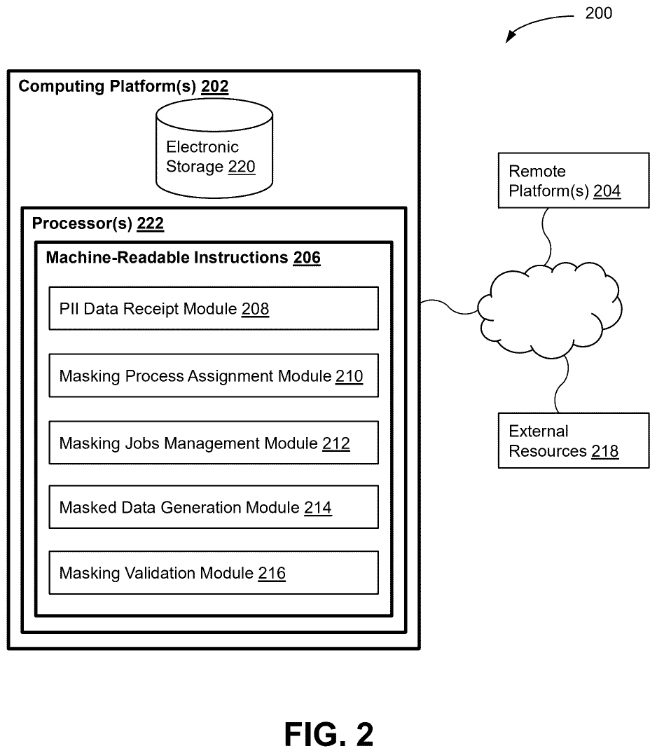

FIG. 2 illustrates a system 200 configured for automated masking of personally identifiable information (PII) data, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of PII data receipt module 208, masking process assignment module 210, masking jobs management module 212, masked data generation module 214, masking validation module 216, and/or other instruction modules.

PII data receipt module 208 may be configured to receive input data comprising personally identifiable information data associated with an input data label. PII data receipt module 208 may be configured to receive input data comprising PII data associated with a plurality of input data labels.

Masking process assignment module 210 may be configured to automatically assign a masking process for the PII data based on a comparison of the input data label with stored masking parameters and based on a set of stored masking processes. The set of stored masking processes may be mapped to a set of input data labels comprising the input data label associated with the PII data. In an embodiment, masking process assignment module 210 may be configured to, for each of a plurality of input data labels, automatically assign, based on a comparison of the input data label with stored data masking parameters, a masking process for the PII data based on a comparison of the input data label and the set of stored masking processes. In an embodiment, masking process assignment module 210 may be configured to automatically assign the masking process based on the input data and based on the comparison of the input data label with the stored data masking parameters.

Masking jobs management module 212 may be configured to automatically create and execute one or more masking jobs associated with the masking process. Masking jobs management module 212 may be configured to automatically create and execute the one or more masking jobs based on a data classification associated with the PII data.

Masked data generation module 214 may be configured to generate masked PII data based on execution of the one or more masking jobs.

Masking validation module 216 may be configured to compare the received PII data and the masked PII data to determine whether masking properly occurred.

In some embodiments, computing platform(s) 202, remote platform(s) 204, and/or external resources 218 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 218 may be operatively linked via some other communication media.

A given remote platform 204 may include one or more processors configured to execute computer program modules. The computer program modules may be configured to enable an expert or user associated with the given remote platform 204 to interface with system 200 and/or external resources 218, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 218 may include sources of information outside of system 200, external entities participating with system 200, and/or other resources. In some embodiments, some or all of the functionality attributed herein to external resources 218 may be provided by resources included in system 200.

Computing platform(s) 202 may include electronic storage 220, one or more processors 222, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 220 may comprise non-transitory storage media that electronically stores information. The electronic storage media of electronic storage 220 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 220 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 220 may include one or more virtual storage resources (e.g., cloud storage, a virtual private network, and/or other virtual storage resources). Electronic storage 220 may store software algorithms, information determined by processor(s) 222, information received from computing platform(s) 202, information received from remote platform(s) 204, and/or other information that enables computing platform(s) 202 to function as described herein.

Processor(s) 222 may be configured to provide information processing capabilities in computing platform(s) 202. As such, processor(s) 222 may include one or more of a digital processor, an analog processor, a digital circuit designed to process information, an analog circuit designed to process information, a state machine, and/or other mechanisms for electronically processing information. Although processor(s) 222 is shown in FIG. 2 as a single entity, this is for illustrative purposes only. In some embodiments, processor(s) 222 may include a plurality of processing units. These processing units may be physically located within the same device, or processor(s) 222 may represent processing functionality of a plurality of devices operating in coordination. Processor(s) 222 may be configured to execute modules 208, 208, 210, 212, 214 and/or 216, and/or other modules. Processor(s) 222 may be configured to execute modules 208, 210, 212, 214 and/or 216, and/or other modules by software; hardware; firmware; some combination of software, hardware, and/or firmware; and/or other mechanisms for configuring processing capabilities on processor(s) 222. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214 and/or 216 are illustrated in FIG. 2 as being implemented within a single processing unit, in embodiments in which processor(s) 222 includes multiple processing units, one or more of modules 208, 210, 212, 214 and/or 216 may be implemented remotely from the other modules. The description of the functionality provided by the different modules 208, 210, 212, 214 and/or 216 described below is for illustrative purposes, and is not intended to be limiting, as any of modules 208, 210, 212, 214 and/or 216 may provide more or less functionality than is described. For example, one or more of modules 208, 210, 212, 214 and/or 216 may be eliminated, and some or all of its functionality may be provided by other ones of modules 208, 210, 212, 214 and/or 216. As another example, processor(s) 222 may be configured to execute one or more additional modules that may perform some or all of the functionality attributed below to one of modules 208, 210, 212, 214 and/or 216.

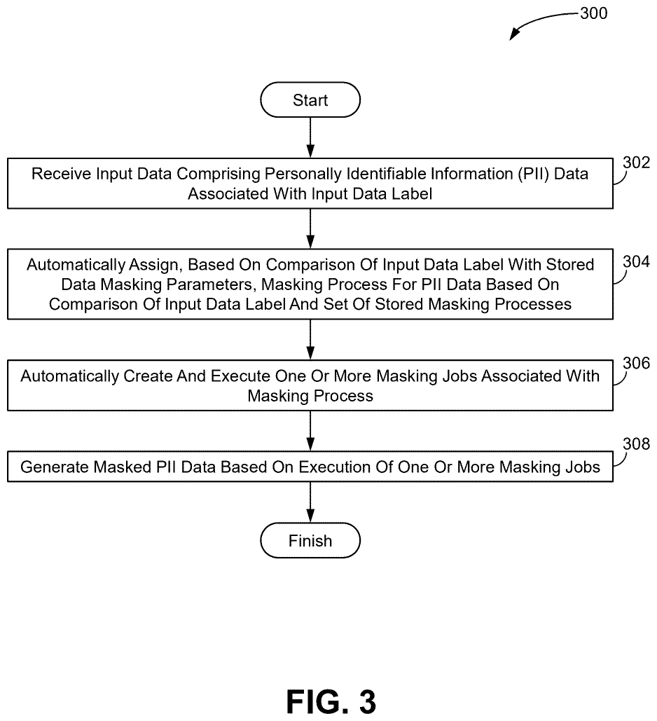

FIG. 3 illustrates a method 300 for automated masking of personally identifiable information data, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include receiving input data comprising personally identifiable information data associated with an input data label. Operation 302 may be performed by one or more hardware processors configured by machine-readable instructions including a module that is the same as or similar to module 208, in accordance with one or more embodiments.

An operation 304 may include automatically assigning a masking process for the PII data based on a comparison of the input data label with stored masking parameters and based on a set of stored masking processes, the set of stored masking processes being mapped to a set of input data labels comprising the input data label associated with the PII data. Operation 304 may be performed by one or more hardware processors configured by machine-readable instructions including a module that is the same as or similar to module 210, in accordance with one or more embodiments.

An operation 306 may include automatically creating and executing one or more masking jobs associated with the masking process. Operation 306 may be performed by one or more hardware processors configured by machine-readable instructions including a module that is the same as or similar to module 212, in accordance with one or more embodiments.

An operation 308 may include generating masked PII data based on execution of the one or more masking jobs. Operation 308 may be performed by one or more hardware processors configured by machine-readable instructions including a module that is the same as or similar to module 214, in accordance with one or more embodiments.

FIG. 4 illustrates is a block and flow diagram of a classification engine 400 of an apparatus configured for automated masking of personally identifiable information data, in accordance with one or more embodiments. The classification engine 400 may be similar to the classification engine 110 in FIG. 1, and one or more functions described here are also applicable to the classification engine in FIG. 1. The classification engine 400 in FIG. 4 may be configured to: receive the file layout metadata 150; and decide, at 402, which field needs to be masked. At 404, the classification engine 400 may determine whether a field is a masked field, also referred to as a field to be masked. If the field is a field to be masked, then at 406 the classification engine 400 may heuristically identify what type of data is included in the field, and at 408 assign a suitable masking algorithm. The heuristic identification may be based on a data type mapping to a set of masking algorithms. If the field is not a field to be masked, no masking actions are taken, as shown at 410. At 412, the classification engine completes the data schema for the masking engine, and provides a classification engine output 414 as an input for the masking engine 500. The classification engine output 414 may comprise the masking schema 416.

FIG. 5 is a block and flow diagram of a masking engine 500 of an apparatus configured for automated masking of personally identifiable information data, in accordance with one or more embodiments. The masking engine 500 may be similar to the masking engine 120 in FIG. 1, and one or more functions described here are also applicable to the masking engine in FIG. 1. The masking engine 500 in FIG. 5 is configured to receive the output 414 of classification engine 400, including a masking schema 416. The masking engine 500 may, in conjunction with a payload template/generator 502, prepare an API payload as shown at 504, and send configuration information, as shown at 506, to an HTTP request/response handler 508. The handler 508 may be in communication with the API 510. A determination may be made at 512 whether the configuration is successful. If the configuration is successful, the masking job kicks off at 514 and the handler monitors the job at 516. A determination is made at 518 whether the masking job has finished successfully. When the job is finished successfully, a masking engine output 520 is provided as an input to the validation engine 600.

FIG. 6 is a block and flow diagram of a validation engine 600 of an apparatus configured for automated masking of personally identifiable information data, in accordance with one or more embodiments. The validation engine 600 may be similar to the validation engine 130 in FIG. 1, and one or more functions described here are also applicable to the masking engine in FIG. 1. In an embodiment, the masking engine output 520 may comprise a job completion signal. The validation engine 600 in FIG. 6 may receive the job completion signal from the masking engine 500, and may retrieve the masked datafile. The validation engine 600 may also receive the unmasked datafile 140, as well as information from the classification engine 400 on the masking schema 416 used. A comparison tool 700 within the validation engine may be configured to determine whether the masking successfully occurred. The comparison tool 700 is configured to generate a validation report based on the result of the comparison tool and the associated determination, for one or more masking operations.

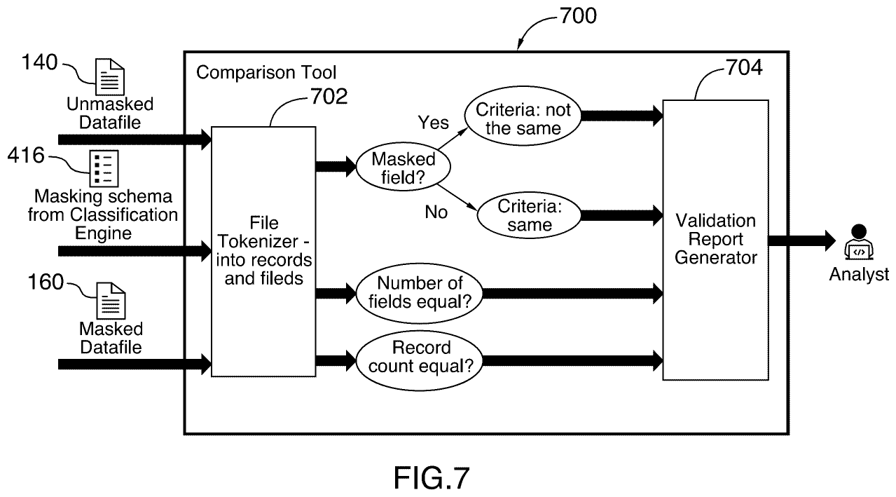

FIG. 7 is a block and flow diagram of a comparison tool 700 of an apparatus configured for automated masking of personally identifiable information data, in accordance with one or more embodiments. The comparison tool 700 may be configured to receive the unmasked data file 140, the masking schema 416 from the classification engine, and the masked datafile 160. A file tokenizer 702 may be configured to tokenize file contents into records and fields, and to do this for both the unmasked datafile 140 and the masked datafile 160. A validation report generator 704 may be configured to generate a validation report based on a determination of whether the number of fields is equal, whether the record count is equal, and whether or not the criteria are the same based on whether a field is a masked field.

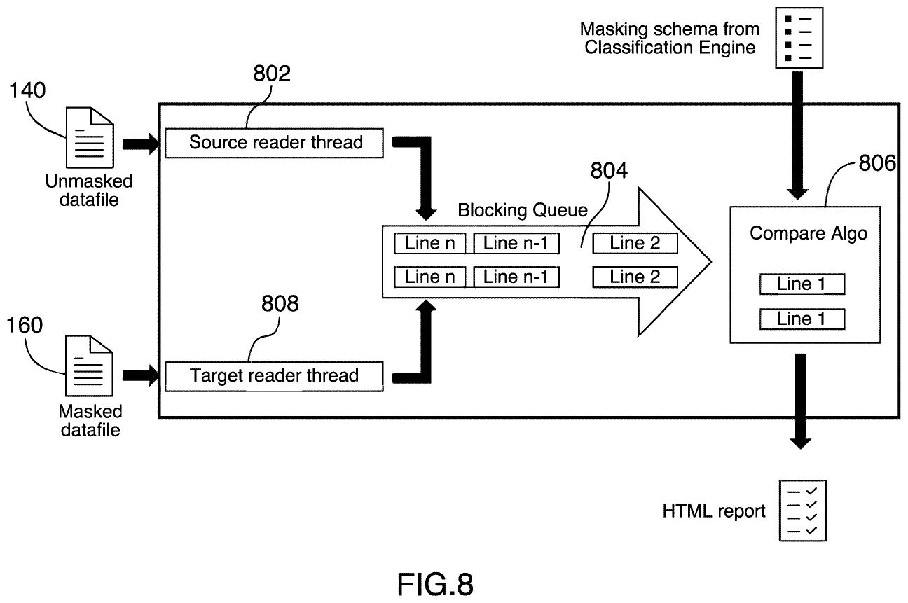

FIG. 8 is a block and flow diagram 800 of a first data comparison example, in accordance with one or more embodiments. As shown in FIG. 8, an unmasked datafile 140 may be provided as an input to a source reader thread 802, which then may be fed into a blocking queue 804, and then to a comparison module 806 which may implement a comparison method or algorithm. A masked datafile 160 may be provided as an input to a target reader thread 808, which then may similarly be fed into the blocking queue 804, and then to the comparison module 806. The blocking queue 804 may be configured to line up blocks of lines from the unmasked datafile 140 and the masked datafile 160. The comparison module 806 may be configured to perform a line-by-line comparison of contents of the unmasked datafile 140 and the masked datafile 160. For example, the comparison module 806 may compare each of a plurality of lines in the unmasked datafile 140 with a corresponding line in the masked datafile 160.

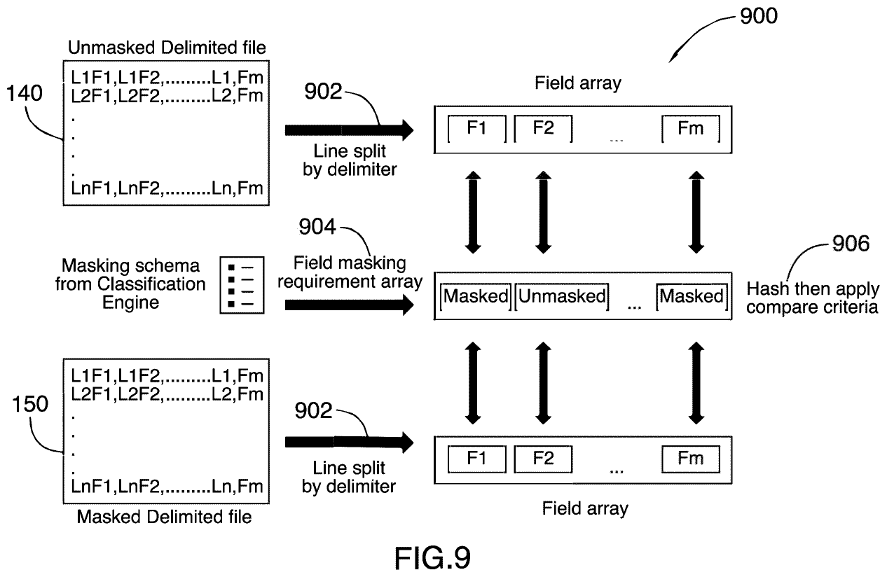

FIG. 9 is a block and flow diagram 900 of a second data comparison example, in accordance with one or more embodiments. FIG. 9 is similar to FIG. 8, and shows the unmasked datafile 140 and the masked datafile 150 being delimited files, and shows the lines split by the delimiter, or blocking queue. The masked and unmasked file contents may be split at 902 by the delimiter and compared to a field masking requirement array 904, indicating whether a field is masked or unmasked. Contents in the field arrays for the unmasked data and the masked data may be compared based on the field masking requirement array. The content of the field masking requirement array may be hashed at 906 and then applied to compare criteria of a portion of the unmasked delimited file and corresponding portion of the masked delimited file.

A system in accordance with one or more embodiments may be configured to ensure that a data schema format of an input file complies with a format required by the automated masking engine, from a configuration perspective, rather than a data format perspective.

A system in accordance with one or more embodiments may be configured to automatically update a project status in Jira based on an output of the automation tool including an update status.

When masking with respect to Hadoop, a system in accordance with one or more embodiments may be configured to extract the data from Hadoop into a file that has a human readable format, then use the file for performing the masking, then covert it back to Hadoop format.

A system in accordance with one or more embodiments may be configured to automate queries relating to the masking automation tool based on stored configuration, and automatically export configuration details or making a configuration modification, in response to a query.

One or more embodiments of the present disclosure provide a platform to automatically identify PII data and automatically mask the PII data based on a selected masking scheme. A system according to one or more embodiments may scan definitions of tables related to the PII data to determine the best masking algorithm to apply, based on a PII data classification, and may automatically create jobs based on classifications. A masking engine may execute and run the jobs in the lower environment. A comparison engine may compare data pre-masking and post-masking, to determine whether masking actually occurred. One or more embodiments of the present disclosure automate the obfuscation of production data in a lower environment quickly, compared to existing manual approaches.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for automated masking of personally identifiable information (PII) data. The system may include one or more hardware processors configured by machine-readable instructions. The processor(s) may be configured to receive input data comprising personally identifiable information (PII) data associated with an input data label. The processor(s) may be configured to automatically assign a masking process for the PII data based on a comparison of the input data label with stored masking parameters and based on a set of stored masking processes, the set of stored masking processes being mapped to a set of input data labels comprising the input data label associated with the PII data. The processor(s) may be configured to automatically create and execute one or more masking jobs associated with the masking process. The processor(s) may be configured to generate masked PII data based on execution of the one or more masking jobs.

In some implementations of the system, the processor(s) may be configured to receive input data comprising PII data associated with a plurality of input data labels. In some implementations of the system, the processor(s) may be configured to, for each of the plurality of input data labels, automatically assign, based on a comparison of the input data label with stored data masking parameters, a masking process for the PII data based on a comparison of the input data label and the set of stored masking processes.

In some implementations of the system, the processor(s) may be configured to automatically assign the masking process based on the input data and based on the comparison of the input data label with the stored data masking parameters.

In some implementations of the system, the processor(s) may be configured to automatically create and execute the one or more masking jobs based on a data classification associated with the PII data.

In some implementations of the system, the processor(s) may be configured to compare the received PII data and the masked PII data to determine whether masking properly occurred.

Another aspect of the present disclosure relates to a processor-implemented method for automated masking of personally identifiable information (PII) data. The method may include receiving input data comprising personally identifiable information (PII) data associated with an input data label. The method may include automatically assigning a masking process for the PII data based on a comparison of the input data label with stored masking parameters and based on a set of stored masking processes, the set of stored masking processes being mapped to a set of input data labels comprising the input data label associated with the PII data. The method may include automatically creating and executing one or more masking jobs associated with the masking process. The method may include generating masked PII data based on execution of the one or more masking jobs.

In some implementations of the method, it may include receiving input data comprising PII data associated with a plurality of input data labels. In some implementations of the method, for each of the plurality of input data labels, it may include automatically assigning, based on a comparison of the input data label with stored data masking parameters, a masking process for the PII data based on a comparison of the input data label and the set of stored masking processes.

In some implementations of the method, it may include automatically assigning the masking process based on the input data and based on the comparison of the input data label with the stored data masking parameters.

In some implementations of the method, it may include automatically creating and executing the one or more masking jobs based on a data classification associated with the PII data.

In some implementations of the method, it may include comparing the received PII data and the masked PII data to determine whether masking properly occurred.

Yet another aspect of the present disclosure relates to a non-transient computer-readable storage medium having instructions embodied thereon, the instructions being executable by one or more processors to perform a method for automated masking of personally identifiable information (PII) data. The method may include receiving input data comprising personally identifiable information (PII) data associated with an input data label. The method may include automatically assigning a masking process for the PII data based on a comparison of the input data label with stored masking parameters and based on a set of stored masking processes, the set of stored masking processes being mapped to a set of input data labels comprising the input data label associated with the PII data. The method may include automatically creating and executing one or more masking jobs associated with the masking process. The method may include generating masked PII data based on execution of the one or more masking jobs.

In some implementations of the computer-readable storage medium, the method may include receiving input data comprising PII data associated with a plurality of input data labels. In some implementations of the computer-readable storage medium, the method may include, for each of the plurality of input data labels, automatically assigning, based on a comparison of the input data label with stored data masking parameters, a masking process for the PII data based on a comparison of the input data label and the set of stored masking processes.

In some implementations of the computer-readable storage medium, the method may include automatically assigning the masking process based on the input data and based on the comparison of the input data label with the stored data masking parameters.

In some implementations of the computer-readable storage medium, the method may include automatically creating and executing the one or more masking jobs based on a data classification associated with the PII data.

In some implementations of the computer-readable storage medium, the method may include comparing the received PII data and the masked PII data to determine whether masking properly occurred.

Still another aspect of the present disclosure relates to a system configured for automated masking of personally identifiable information (PII) data. The system may include means for receiving input data comprising personally identifiable information (PII) data associated with an input data label. The system may include means for automatically assigning a masking process for the PII data based on a comparison of the input data label with stored masking parameters and based on a set of stored masking processes, the set of stored masking processes being mapped to a set of input data labels comprising the input data label associated with the PII data. The system may include means for automatically creating and executing one or more masking jobs associated with the masking process. The system may include means for generating masked PII data based on execution of the one or more masking jobs.

In some implementations of the system, the system may include means for receiving input data comprising PII data associated with a plurality of input data labels. In some implementations of the system, the system may include means for, for each of the plurality of input data labels, automatically assigning, based on a comparison of the input data label with stored data masking parameters, a masking process for the PII data based on a comparison of the input data label and the set of stored masking processes.

In some implementations of the system, the system may include means for automatically assigning the masking process based on the input data and based on the comparison of the input data label with the stored data masking parameters.

In some implementations of the system, the system may include means for automatically creating and executing the one or more masking jobs based on a data classification associated with the PII data.

In some implementations of the system, the system may include means for comparing the received PII data and the masked PII data to determine whether masking properly occurred.

Even another aspect of the present disclosure relates to a computing platform configured for automated masking of personally identifiable information (PII) data. The computing platform may include a non-transient computer-readable storage medium having executable instructions embodied thereon. The computing platform may include one or more hardware processors configured to execute the instructions. The processor(s) may execute the instructions to receive input data comprising personally identifiable information (PII) data associated with an input data label. The processor(s) may execute the instructions to automatically assign a masking process for the PII data based on a comparison of the input data label with stored masking parameters and based on a set of stored masking processes, the set of stored masking processes being mapped to a set of input data labels comprising the input data label associated with the PII data. The processor(s) may execute the instructions to automatically create and execute one or more masking jobs associated with the masking process. The processor(s) may execute the instructions to generate masked PII data based on execution of the one or more masking jobs.

In some implementations of the computing platform, the processor(s) may execute the instructions to receive input data comprising PII data associated with a plurality of input data labels. In some implementations of the computing platform, the processor(s) may execute the instructions for each of the plurality of input data labels, automatically assigning, based on a comparison of the input data label with stored data masking parameters, a masking process for the PII data based on a comparison of the input data label and the set of stored masking processes.

In some implementations of the computing platform, the processor(s) may execute the instructions to automatically assign the masking process based on the input data and based on the comparison of the input data label with the stored data masking parameters.

In some implementations of the computing platform, the processor(s) may execute the instructions to automatically create and execute the one or more masking jobs based on a data classification associated with the PII data.

In some implementations of the computing platform, the processor(s) may execute the instructions to compare the received PII data and the masked PII data to determine whether masking properly occurred.

What is claimed is:

1. An apparatus configured for automated masking of personally identifiable information (PII) data, the apparatus comprising:
a non-transient computer-readable storage medium having executable instructions embodied thereon; and
one or more hardware processors configured to execute the instructions to:
receive input data comprising PII data associated with an input data label;
automatically assign a masking process for the PII data based on a comparison of the input data label with stored masking parameters and based on a set of stored masking processes, the set of stored masking processes being mapped to a set of input data labels comprising the input data label associated with the PII data;
automatically create and execute one or more masking jobs associated with the masking process; and
generate masked PII data based on execution of the one or more masking jobs.

2. The apparatus of claim 1 wherein the one or more hardware processors are further configured to execute the instructions to:
automatically create and execute the one or more masking jobs based on a data classification associated with the PII data.

3. The apparatus of claim 1 wherein the one or more hardware processors are further configured to execute the instructions to:
receive input data comprising PII data associated with a plurality of input data labels;
for each of the plurality of input data labels, automatically assign, based on a comparison of the input data label with stored data masking parameters, a masking process for the PII data based on a comparison of the input data label and the set of stored masking processes.

4. The apparatus of claim 1 wherein the one or more hardware processors are further configured to execute the instructions to:
automatically assign the masking process based on the input data and based on the comparison of the input data label with the stored data masking parameters.

5. The apparatus of claim 1 wherein the one or more hardware processors are further configured to execute the instructions to:
compare the received PII data and the masked PII data to determine whether masking properly occurred.

6. The apparatus of claim 1 wherein the one or more hardware processors are further configured to execute the instructions to:
compare the received PII data and the masked PII data to determine whether masking properly occurred.

7. The apparatus of claim 6 wherein the one or more hardware processors are further configured to execute the instructions to:
generate a validation report based on the comparing the received PII data and the masked data for one or more masking operations.

8. The apparatus of claim 1 wherein the one or more hardware processors are further configured to execute the instructions to:
intercept the input data comprising the PII data before the input data is passed to a lower environment.

9. The apparatus of claim 1 wherein the one or more hardware processors are further configured to execute the instructions to:
when the input data label comprises a field name,
automatically assign the masking process based on a comparison of the field name and the set of stored masking processes, the set of stored masking processes being mapped to a set of field names comprising the field name associated with the PII data or comprising an alternative field name similar to the field name associated with the PII data.

10. A processor-implemented method of automated masking of personally identifiable information (PII) data, the method comprising:
receiving input data comprising personally identifiable information (PII) data associated with an input data label;
automatically assigning a masking process for the PII data based on a comparison of the input data label with stored masking parameters and based on a set of stored masking processes, the set of stored masking processes being mapped to a set of input data labels comprising the input data label associated with the PII data;
automatically creating and executing one or more masking jobs associated with the masking process; and
generating masked PII data based on execution of the one or more masking jobs.

11. The method of claim 10 further comprising:
receiving input data comprising PII data associated with a plurality of input data labels;
for each of the plurality of input data labels, automatically assigning, based on a comparison of the input data label with stored data masking parameters, a masking process for the PII data based on a comparison of the input data label and the set of stored masking processes.

12. The method of claim 10 further comprising:
automatically assigning the masking process based on the input data and based on the comparison of the input data label with the stored data masking parameters.

13. The method of claim 10 further comprising:
automatically creating and executing the one or more masking jobs based on a data classification associated with the PII data.

14. The method of claim 10 further comprising:
comparing the received PII data and the masked PII data to determine whether masking properly occurred.

15. The method of claim 14 further comprising:
generating a validation report based on the comparing the received PII data and the masked data for one or more masking operations.

16. The method of claim 10 further comprising:
intercepting the input data comprising the PII data before the input data is passed to a lower environment.

17. The method of claim 10 wherein the input data label comprises a field name and the method comprises automatically assigning the masking process based on a comparison of the field name and the set of stored masking processes, the set of stored masking processes being mapped to a set of field names comprising the field name associated with the PII data or comprising an alternative field name similar to the field name associated with the PII data.

18. The method of claim 10 further comprising:
automatically providing a project status update based on completion of the one or more masking jobs.

19. A non-transient computer-readable storage medium having instructions embodied thereon, the instructions being executable by one or more processors to perform a method of automated masking of personally identifiable information (PII) data, the method comprising:
receiving input data comprising personally identifiable information (PII) data associated with an input data label;
automatically assigning a masking process for the PII data based on a comparison of the input data label with stored masking parameters and based on a set of stored masking processes, the set of stored masking processes being mapped to a set of input data labels comprising the input data label associated with the PII data;
automatically creating and executing one or more masking jobs associated with the masking process; and
generating masked PII data based on execution of the one or more masking jobs.

20. The non-transient computer-readable storage medium of claim 19 wherein the method further comprises:
comparing the received PII data and the masked PII data to determine whether masking properly occurred.
